(19) United States
(12) Patent Application Publication
(10) Pub. No.: US 2012/0076984 A1
(43) Pub. Date: Mar. 29, 2012

(54) Biaxially Oriented Poly(Arylene Sulfide) Resin Film and Process for Production of Same

(76) Inventors: Aoi Miyazaki, Tokyo (JP); Masayuki Hino, Tokyo (JP); Tomonori Hosoda, Tokyo (JP); Hiroyuki Oba, Tokyo (JP); Satoshi Usui, Tokyo (JP)

(21) Appl. No.: 13/376,950

(22) PCT Filed: May 28, 2010
(86) PCT No.: PCT/JP2010/059068

§ 371 Date: Dec. 8, 2011

(30) Foreign Application Priority Data
Jun. 11, 2009 (JP) 2009-140243

(51) Int. Cl. B32B 5/00; B29C 47/88

(52) U.S. Cl. 428/141; 264/108

(57) ABSTRACT

A biaxially oriented poly(arylene sulfide) resin film formed from a resin composition including a syndiotactic polystyrene resin by a ratio of from 0.1 to 30 parts by mass with respect to 100 parts by mass of a poly(arylene sulfide) resin, which has a center line average roughness Ra in the range of from 0.01 to 0.09 μm and a maximum height Rmax of 1.0 μm or less, a static friction coefficient of 1.00 or less and a kinetic friction coefficient of 0.70 or less, and a process for the production of the same.

### TECHNICAL FIELD

The present invention relates to a biaxially oriented poly(arylene sulfide) resin film having highly balanced surface flatness and slippage that are conflicting properties. More specifically, the present invention relates to a biaxially oriented poly(arylene sulfide) resin film that has small friction coefficients and exerts suitable slippage despite of its small surface roughness and excellent surface flatness, and a process for the production of the same.

### BACKGROUND ART

Poly(arylene sulfide) resins (hereinafter abbreviated as “PAS resins”) such as poly(phenylene sulfide) resins (hereinafter abbreviated as “PPS resins”) are one of engineering plastics, and can be formed into biaxially oriented films by extrusion molding and orientation processing. Biaxially oriented PAS resin films are excellent in heat resistance, chemical resistance, resistance to hydrolysis, flame retardency, mechanical strength, electrical property, size stability and the like.

In order to form a biaxially oriented film by using a PAS resin, in general, an unstretched sheet is prepared by a process including putting a PAS resin into an extruder, melt extruding the resin into a sheet form from a T die disposed on the tip of the extruder, and rapidly cooling the film by casting on a casting roll. Then, the unstretched sheet is biaxially oriented by a simultaneous biaxial orientation process or sequential biaxial orientation process. The simultaneous biaxial orientation process is poorer than the sequential biaxial orientation process in producibility. Therefore, it is preferable to adopt the sequential biaxial orientation process as an orientation process.

In the sequential biaxial orientation process, in general, an unstretched sheet is contacted with a group of rolls consisting of a preheating roll, a pre-orientation roll (low-speed roll) and a post-orientation roll (high-speed roll) and heated to an orientation temperature, while the sheet is monoaxially oriented (oriented between the rolls) in the machine direction by utilizing the difference between the rotation velocities of the low-speed roll and high-speed roll. The film that has been monoaxially oriented in the machine direction is then introduced into a tenter orientation machine, heated to an orientation temperature under a high temperature atmosphere, and oriented in the traverse direction. The biaxially oriented film is heat-fixed and rolled up into a roll by a winding machine.

A biaxially oriented PAS resin film formed from a PAS resin has an extremely small surface roughness and excellent surface flatness. Therefore, the biaxially oriented PAS resin film has large surface friction coefficients and insufficient slippage. As a result, the biaxially oriented PAS resin film is difficult to be oriented stably between rolls during film formation steps. Furthermore, the biaxially oriented PAS resin film has poor slippage between films, and thus generates wrinkles easily during rolling-up into a roll.

A biaxially oriented PAS resin film rolled up into a roll is sometimes rewound so as to be fed to the next processing step, but it is difficult to be rewound smoothly since it has poor slippage between films. For example, in order to produce a condenser film in which a metal-deposited film is formed on one surface of a biaxially oriented PAS resin film, a biaxially oriented PAS resin film rolled up into a roll should be rewound; however, since smooth rewinding is difficult, the production conditions are limited. Furthermore, since the condenser film had poor slippage between the surface of the metal-deposited film and the surface of the biaxially oriented PAS resin film, defective products are easily generated unless conditions such as winding, cutting and secondary processing are strictly controlled.

As mentioned above, a biaxially oriented PAS resin film is excellent in surface flatness but is poor in slippage, and thus the conditions for the production steps and processing steps thereof are difficult to control. Therefore, in the case when a biaxially oriented PAS resin film is produced by a sequential biaxial orientation process, an inorganic filler such as calcium carbonate and silica is generally incorporated in a PAS resin. By using a PAS resin composition including a solid additive such as an inorganic filler, film production of a biaxially oriented PAS resin film including a step of orientation between rolls can be carried out smoothly. In addition, the obtained biaxially oriented PAS resin film has a suitable surface roughness and is excellent in slippage.

When the slippage of a biaxially oriented PAS resin film formed from a PAS resin composition including an inorganic filler becomes too high, the film would around a roll is loosen easily, or the running stability on the roll is lost, thereby the handling property is decreased. When the surface roughness of the biaxially oriented PAS resin film is too large, the flatness thereof is lost. Therefore, the flatness and slippage of the biaxially oriented PAS resin film are suitably balanced by using a PAS resin composition including an inorganic filler such as calcium carbonate by a small amount ratio.

On the other hand, due to the progress in precise thin film-forming technique and coating technique in recent years, the level of required flatness of films have been increased. However, it is difficult to highly balance flatness and slippage in a biaxially oriented PAS resin film including an inorganic filler. The secondary flocculated particles of the inorganic filler included in the biaxially oriented PAS resin film are observed as protrusions on the surface of the biaxially oriented PAS resin film. When the biaxially oriented PAS resin film is used as a release film in steps for the production of electronic parts, fine concaves and convexes such as protrusions are transferred to a thin copper foil. When solid particles such as the inorganic filler drop off from the biaxially oriented PAS resin film used as a release film, they contaminate adherends such as a circuit substrate and a copper foil surface.

To be specific, for example, Japanese Patent Application Laid-Open (JP-A) No. 9-278912 (Patent Literature 1) and JP-A No. 9-300365 (Patent Literature 2) each discloses a biaxially aligned poly(phenylene sulfide) film for mold releasing, which includes a lubricant such as a silica micropowder and has an average surface roughness Ra of from 0.005 to 0.03 μm.

JP-A No. 2006-21372 (Patent Literature 3) discloses a laminate film for mold releasing, which includes a resin composition layer having a heat deformation temperature of from 70 to 150° C., and biaxially oriented poly(phenylene sulfide) films that are formed from a poly(phenylene sulfide) resin composition including a lubricant such as a calcium carbonate powder and are laminated on the both surfaces of the resin composition layer.

JP-A No. 2004-149740 (Patent Literature 4) discloses a biaxially aligned poly(phenylene sulfide) film whose slippage is improved by incorporating calcium carbonate microparticles in the biaxially aligned poly(phenylene sulfide) resin film, and a condenser obtained by depositing a metal layer on the film.

However, a biaxially oriented PAS resin film including an inorganic filler such as calcium carbonate and silica has problems that coarse protrusions due to the secondary flocculate of the inorganic filler are formed easily, voids are generated easily around the inorganic filler during orientation processing, the inorganic filler easily drops off from the film, and the like. In order to apply a biaxially oriented PAS resin film to applications as electrical and electronic parts such as condenser films and insulating films, it is necessary to highly balance flatness and slippage without incorporating an inorganic filler.

Biaxially oriented PAS resin films are used as carrier films for ultrathin copper foils having a film thickness of from about 1.5 to 5.0 μm. Furthermore, a thin liquid crystal film having a film thickness of from about 0.5 to 5.0 μm is difficult to be produced from a liquid crystal material by itself, and thus it is produced by a process including forming a thin film of a liquid crystal material on a substrate composed of a biaxially oriented PAS resin film. A biaxially oriented PAS resin film including an inorganic filler includes fine concaves and convexes derived from the inorganic filler that are formed on the surface. Therefore, when the biaxially oriented PAS resin film is used as a substrate for forming a carrier film for a ultrathin copper foil or a ultrathin liquid crystal film, the concaves and convexes are easily transferred to the surface of the ultrathin copper foil or ultrathin liquid crystal film. Furthermore, the ultrathin copper foil or the liquid crystal film is often hard to be peeled off from the biaxially oriented PAS resin film. Similar problems are also observed during formation of functional polymer thin films other than liquid crystal films.

A release film is used in steps for the preparation of circuit substrates. For example, when a cover lay film on which a thermosetting adhesive layer has been disposed is attached by heat pressing to a flexible print substrate on which an electrical circuit has been formed, a release film is disposed between the cover lay film and a press hot plate so as to prevent the cover lay film from attaching to the press hot plate.

In steps for the production of a multilayer printed-wiring substrate, the both surfaces of a pair of copper clad laminate plates are used as outer layers, one or more layers of inner layer circuit plates are stacked alternately through prepregs on the inner side thereof, these are clipped with jigs, and the prepregs are cured by heat pressing, thereby a laminate in which the respective layers are integrated is formed. Plural multilayer printed-wiring boards are produced simultaneously by heat press in many cases, and at that time, release films are inserted between the respective multilayer printed-wiring boards so as to protect the multilayer printed-wiring boards to prevent the multilayer printed-wiring boards from attaching to each other and to prevent the multilayer printed-wiring boards from scratching. A prepreg is obtained by impregnating a substrate such as glass cloth and paper with a thermosetting resin such as phenol resins, epoxy resins and polyester resins. Also in the case when plural single-layer printed-wiring boards are simultaneously produced by heat press, release films are inserted between the respective printed-wiring boards so as to prevent the printed-wiring boards from attaching to each other and to prevent the printed-wiring boards from scratching.

In the case when a one-surface copper clad laminate board for printed-wiring boards is produced by superposing a copper foil whose both surfaces have been roughened and a prepreg, plural combinations of the copper foil and prepreg are superposed and heat-pressed to produce plural copper clad laminate boards simultaneously. At that time, a release film is interposed between each combination of the copper foil and prepreg to protect the roughened surface of the copper foil.

As mentioned above, release films are widely used in the steps for the production of circuit substrates. Since heat pressing is carried out under conditions of a high temperature and a long time in a step for heat pressing, release films are required to have excellent heat resistance, excellent resistance against out gas from an adhesive or an insulating resin, excellent resistance against decomposition by moisture, and the like. Release films attach to an abutting surface such as a substrate by heat pressing. Release films are required to have excellent surface flatness, and excellent peeling property that allows easy peeling from the surface of an adherend (a material as an object of attachment) after heat pressing.

Biaxially oriented PAS resin films have many properties that are required for release films such as heat resistance, chemical resistance, resistance to hydrolysis, mechanical strength and size stability, but have problems that it is difficult to highly balance flatness and slippage, and that peeling property tends to be insufficient depending on an object for application.

JP-A No. 11-349703 (Patent Literature 5) discloses a release film composed of a cast film of a resin including a syndiotactic styrene-based polymer as a main component. However, since the resin is a resin composition obtained by adding a thermoplastic resin such as a styrene butadiene rubber to a syndiotactic styrene-based polymer, the cast film therefrom has insufficient properties such as heat resistance and chemical resistance.

JP-A No. 2-175228 (Patent Literature 6) discloses that the molding property and orientation property of a PAS resin can be improved by incorporating a syndiotactic polystyrene in the PAS resin, and a biaxially oriented PAS resin film whose size is changed little up to 220° C. can be obtained even by a heat treatment under mild conditions. However, Patent Literature 6 fails to disclose about a finding relating to the surface roughness, friction coefficients, slippage, release property and the like of the biaxially oriented PAS resin film.

In addition, it is difficult to obtain a biaxially oriented PAS resin film that is significantly excellent in both flatness and slippage and also has sufficient peeling property, under the production conditions including the simultaneous biaxial orientation process and the heat treatment under mild conditions that are specifically disclosed in Patent Literature 6. For example, Example 1 of Patent Literature 6 shows that the biaxially oriented PAS resin film was heat-fixed at 260° C. for 30 seconds without relaxation of the film after the simultaneous biaxially orientation. However, the biaxially oriented PAS resin film obtained by the process may shrink and curl when it is subjected to a press processing at a high temperature for a long time upon application as a release film or the like, and consequently tends to be poor in peeling property.

### CITATION LIST

### Patent Literature

Patent Literature 1: JP-A No. 9-278912
Patent Literature 2: JP-A No. 9-300365
Patent Literature 3: JP-A No. 2006-21372
Patent Literature 4: JP-A No. 2004-149740
Patent Literature 5: JP-A No. 11-349703
Patent Literature 6: JP-A No. 2-175228 (a counterpart of EP0358135)

### SUMMARY OF INVENTION

### Technical Problem

The problem of the present invention is to provide a biaxially oriented poly(arylene sulfide) resin film having highly balanced surface flatness and slippage and also having excellent release property without using a solid additive such as an inorganic filler as a lubricant, and a process for the production of the same.

The present inventors have done intensive studies so as to solve the above-mentioned problem. As a result, they have found that a biaxially oriented PAS resin film that is excellent in slippage and also excellent in release property despite that it is significantly excellent in surface flatness, is obtained, by a process including a combination of a step including preparing a mixture by mixing a pellet of a PAS resin and a pellet of a syndiotactic polystyrene resin (hereinafter abbreviated as “SPS resin”) so that the ratio of the SPS resin against 100 parts by mass of the PAS resin becomes from 0.1 to 30 parts by mass; a step including feeding the mixture to an extruder, and melt-extruding the melt extrusion into a sheet form from a T die attached to the tip of the extruder to form an unstretched sheet; a step including conducting sequential biaxially orientation under specific conditions for film formation; and a step including conducting heat-fixing under specific relaxation conditions.

The biaxially oriented PAS resin film of the present invention has extremely small center line average roughness Ra and maximum height Rmax, and is significantly excellent in surface flatness. The biaxially oriented PAS resin film of the present invention has small static friction coefficient and kinetic friction coefficient between films and is imparted fine and suitable slippage, despite that it has a small surface roughness and is excellent in flatness. Therefore, the biaxially oriented PAS resin film of the present invention does not attach to a metal roll nor generate wrinkles during rolling-up into a roll in the production steps thereof. The biaxially oriented PAS resin film of the present invention can be rewound smoothly from a rolled-up roll.

Since the biaxially oriented PAS resin film of the present invention is excellent in slippage, it is easily processed into various applications such as condenser films and carrier films. Furthermore, since the biaxially oriented PAS resin film of the present invention can be easily peeled off from an adherend after heat pressing at a high temperature and for a long time, it can exert properties that are suitable for release films in the steps of the production of circuit substrates. The present invention has been completed based on these findings.

### Solution to Problem

Accordingly, the present invention provides a biaxially oriented poly(arylene sulfide) resin film formed from a resin composition including a syndiotactic polystyrene resin by a ratio of from 0.1 to 30 parts by mass with respect to 100 parts by mass of a poly(arylene sulfide) resin, which has

(a) a center line average roughness Ra in the range of from 0.01 to 0.09 μm and a maximum height Rmax of 1.0 μm or less, which are measured according to the specification of JIS B 0601-1982 in the Japanese Industrial Standards, and

(b) a static friction coefficient of 1.00 or less and a kinetic friction coefficient of 0.70 or less, which are measured according to the specification of JIS K 7125 in the Japanese Industrial Standards.

Further, the present invention provides a process for the production of a biaxially oriented poly(arylene sulfide) resin film, which includes the following steps 1 to 5:

(1) step 1, which includes mixing a poly(arylene sulfide) resin pellet and a syndiotactic polystyrene resin pellet so that the ratio of the syndiotactic polystyrene resin with respect to 100 parts by mass of the poly(arylene sulfide) resin becomes from 0.1 to 30 parts by mass to prepare a mixture;

(2) step 2, which includes feeding the mixture to an extruder, melt-kneading the mixture at a temperature in the range of from 280 to 340° C., melt-extruding the mixture into a sheet form from a T die attached to the tip of the extruder, and then contacting the sheet-like melt product with a casting drum whose surface temperature is retained in the range of from 20 to 60° C. to rapidly cool the sheet-like melt product to form an unstretched sheet;

(3) step 3, which includes heating the unstretched sheet by contacting with a group of rolls consisting of a preheating roll, a low-speed roll and a high-speed roll whose surface temperatures are respectively adjusted to the range of from 80 to 95° C., while monoaxially orienting the unstretched sheet between the rolls so as to have a draw ratio in the range of from 2.0 to 5.0 times in the machine direction;

(4) step 4, which includes introducing the film that has been monoaxially oriented in the machine direction into a tenter orientation machine, and heating the film under an atmosphere temperature in the range of from 80 to 95° C. while orienting the film by a draw ratio in the range of from 2.0 to 5.0 times in the traverse direction by a tenter having a shape spreading toward the end; and

(5) step 5, which includes relaxing the biaxially oriented film obtained in the step 4 at a relaxation rate in the range of from 0.5 to 7% in the traverse direction by shortening the distance between clips of the tenter orientation machine, and heat-fixing the film by retaining the film in that state in an atmosphere in the range of more than 260° C. and 295° C. or less for from 35 to 120 seconds.

### Advantageous Effects of Invention

According to the present invention, a biaxially oriented PAS resin film having highly balanced surface flatness and slippage and having excellent release property is provided without using an inorganic filler as a lubricant. The biaxially oriented PAS resin film of the present invention is excellent in film forming property, orientation property, processability and the like. The biaxially oriented PAS resin film of the present invention is excellent in heat resistance, chemical resistance, resistance to hydrolysis, size stability, peeling property and the like that are suitable for release films that are used in the production steps of circuit substrates.

### DESCRIPTION OF EMBODIMENTS

1. Poly(arylene sulfide) Resin (PAS Resin)

The PAS resin used in the present invention is an aromatic polymer including repeating units of an arylene sulfide represented by the structural formula [-Ar-S—] (wherein -Ar- is an arylene group) as a primary constitutional element. When [-Ar-S—] is defined as 1 mol (basic mol), the PAS resin used in the present invention is a polymer including the repeating units by generally 50 mol % or more, preferably 70 mol % or more, more preferably 90 mol % or more.

Examples of the arylene group may include a p-phenylene group, a m-phenylene group, substituted phenylene groups (wherein the substituent is preferably an alkyl group having 1 to 6 carbon atoms or a phenyl group), a p,p′-diphenylenesulfone group, a p,p′-biphenylene group, a p,p′-diphenylenecarbonyl group, a naphthylene group and the like. As the PAS resin, a polymer primarily having the same arylene groups can preferably be used, but a copolymer including two or more kinds of arylene groups can also be used in view of processability and heat resistance.

Among these PAS resins, a PPS resin including repeating units of p-phenylene sulfide as a primary constitutional element is specifically preferable since it is excellent in processability and is industrially readily available. Furthermore, examples of the PAS resin may include poly(arylene ketone)sulfides, poly(arylene ketone ketone)sulfides and the like. Specific examples of the copolymer may include random or block copolymers having repeating units of p-phenylene sulfide and repeating units of m-phenylene sulfide, random or block copolymers having repeating units of phenylene sulfide and repeating units of arylene ketone sulfide, random or block copolymers having repeating units of phenylene sulfide and repeating units of arylene ketone ketone sulfide, random or block copolymers having repeating units of phenylene sulfide and repeating units of arylene sulfone sulfide, and the like.

These PAS resin are generally crystalline polymers. It is preferable that the PAS resin is a linear polymer in view of toughness, strength and the like. PAS resins such as PPS resins generally include two types. One of which is a type obtained by obtaining a polymer having a low polymerization degree by polymerization, and heating the polymer in the presence of oxygen to partially crosslink the polymer to impart a high molecular weight. This is generally referred to as a crosslinking type. Another one is a type obtained by obtaining a polymerized product having a high molecular weight during polymerization. This is generally referred to as a linear type. A little amount of a branched structure and/or a crosslinked structure may be introduced in linear PAS resins.

PAS resins can be obtained by a known process in which a sulfur source and a di-halogen-substituted aromatic compound are subjected to a polymerization reaction in a polar solvent. Examples of typical sulfur sources include alkali metal sulfides, alkali metal hydrogen sulfides, and mixtures thereof. The alkali metal sulfides include lithium sulfide, sodium sulfide, potassium sulfide, rubidium sulfide, cesium sulfide and the like. The alkali metal hydrogen sulfides include lithium hydrogen sulfide, sodium hydrogen sulfide, potassium hydrogen sulfide, rubidium hydrogen sulfide, cesium hydrogen sulfide and the like. In the case when the sulfur source includes an alkali metal hydrogen sulfide, an alkali metal hydroxide is used in combination. Examples of the alkali metal hydroxide include lithium hydroxide, sodium hydroxide, potassium hydroxide, rubidium hydroxide, cesium hydroxide and the like.

Examples of the di-halogen-substituted aromatic compound may include p-dichlorobenzene, m-dichlorobenzene, 2,5-dichlorotoluene, p-dibromobenzene, 2,6-dichloronaphthalene, 1-methoxy-2,5-dichlorobenzene, 4,4′-dichlorobiphenyl, 3,5-dichlorobenzoic acid, p,p′-dichlorodiphenyl ether, 4,4′-dichlorodiphenyl sulfone, 4,4′-dichlorodiphenyl ether, 4,4′-dichlorodiphenyl sulfoxide, 4,4′-dichlorodiphenyl ketone and the like. Each of these can be used solely, or two or more kinds can be used in combination. Among these, p-dichlorobenzene and m-dichlorobenzene are preferable, and p-dichlorobenzene is more preferable.

In order to introduce some branched structure or crosslinking structure in the PAS resin, a small amount of a poly-halogen-substituted aromatic compound having three or more halogen substituents per one molecule can be used in combination. Examples of the poly-halogen-substituted aromatic compound may include tri-halogen-substituted aromatic compounds such as 1,2,3-trichlorobenzene, 1,2,3-tribromobenzene, 1,2,4-trichlorobenzene, 1,2,4-tribromobenzene, 1,3,5-trichlorobenzene 1,3,5-tribromobenzene, and 1,3-dichloro-5-bromobenzene, and alkyl-substituted forms thereof. Each of these can be used solely, or two or more kinds can be used in combination. Among these, 1,2,4-trichlorobenzene, 1,3,5-trichlorobenzene and 1,2,3-trichlorobenzene are more preferable in view of economic efficiency, reactivity, physical properties and the like.

As the polar solvent, aprotic organic amide solvents including N-alkylpyrrolidones such as N-methyl-2-pyrrolidone, 1,3-dialkyl-2-imidazolidinone, tetraalkylureas, hexaalkylphosphate triamides and the like are preferable since the stability of the reaction system is high and a polymer having a high molecular weight is easily obtained.

The melting viscosity measured at a temperature of 310° C. and a shear rate of 1,200/sec of the PAS resin used in the present invention is in the range of generally preferably from 20 to 2,000 Pa·s, more preferably from 30 to 1,800 Pa·s, further preferably from 40 to 1,500 Pa·s. When the melting viscosity of the PAS resin is too small, the mechanical physical properties of the biaxially oriented film become insufficient, whereas when the melting viscosity is too high, extrusion molding property is deteriorated.

### 2. Syndiotactic Polystyrene Resin (SPS Resin)

The syndiotactic polystyrene resins (SPS resins) used in the present invention are polystyrenes having a highly syndiotactic structure, in other words, mean polystyrenes whose main chain mainly has a syndiotactic steric configuration. Namely, syndiotactic polystyrene resins are polystyrenes having mainly a steric structure including asymmetric carbon atoms that constitute the main chain thereof and side chain (substituted) phenyl groups that are disposed alternately in reverse directions.

The racemic pentad tacticity of the SPS resin quantified by a nuclear magnetic resonance method is preferably 50% or more, more preferably 80% or more, further preferably 90% or more, and specifically preferably 95% or more. The SPS resin used in the present invention is desirably polystyrenes having a racemic pentad tacticity of 90% or more, further a high syndiotacticity of 95% or more.

Examples of the polystyrenes that constitute the SPS resin may include polystyrenes; poly(alkylstyrene) having one or more alkyl groups having 1 to 5 carbon atoms such as poly(methylstyrene), poly(dimethylstyrene) and poly(t-butylstyrene); poly(halogenated styrene) such as poly(chlorostyrene), poly(bromostyrene), poly(fluorostyrene) and poly(o-methyl-p-fluorostyrene); poly(halogen-substituted alkylstyrene) such as poly(chloromethylstyrene); poly(alkoxystyrene) such as poly(methoxystyrene) and poly(ethoxystyrene); poly(carboxyesterstyrene) such as poly(carboxymethylstyrene); poly(alkylether styrene) such as poly(vinylbenzyl propyl ether); poly(alkylsilylstyrene) such as poly(trimethylsilylstyrene); poly(ethyl vinylbenzene sulfonate), poly(vinylbenzyldimethoxyphosphide), and the like.

Each of these polystyrenes can be used solely, or two or more kinds can be used in combination. These polystyrenes may be copolymers including styrene or a styrene derivative as a main component. Among these polystyrenes, syndiotactic polystyrenes (homopolymers) are preferable in view of heat resistance, crystallization velocity and the like. The SPS resin may also include a small amount of other component such as an elastomer.

The weight average molecular weight (Mw) measured by gel permeation chromatography (GPC) of the SPS resin used in the present invention is preferably 10,000 or more, more preferably 50,000 or more, specifically preferably 100,000 or more. The upper limit value of the weight average molecular weight is generally 1,000,000, and 700,000 in many cases.

The melt flow rate (MFR) of the SPS resin used in the present invention is, when it is measured at a temperature of 300° C. and under a load of 1.20 kgf, preferably 3 g/10 min or more, more preferably 5 g/10 min or more, specifically preferably 8 g/10 min or more. The upper limit value of the MFR is generally 50 g/10 min, and 40 g/10 min in many cases. The MFR is sometimes measured at a temperature of 300° C. and under a load of 2.16 kgf depending on the grade of the SPS resin, and in such case, the MFR is preferably 5 g/10 min or more, more preferably 8 g/10 min or more, and the upper limit value thereof is preferably 50 g/10 min When the MFR of the SPS resin is too low, melt-kneading with the PAS resin in an extruder may become uneven, or the operation of the extruder may become instable.

The melting point (Tm) of the SPS resin measured by using differential scanning calorimetry is preferably in the range of from 250 to 310° C., more preferably in the range of from 260 to 290° C., specifically preferably in the range of from 265 to 275° C. Due to the high melting point of the SPS resin, decrease in the heat resistance of a biaxially oriented PAS resin film including the SPS resin can be suppressed.

The SPS resin is a polymer having a high melting point and a fast crystallization velocity, and it is assumed to be able to exert a function as a lubricant by dispersing as particles having a suitable size (1 to 10 μm) around the surface layer of the biaxially oriented PAS resin film by strictly controlling the conditions for film formation. The tendency of the SPS resin particles in the biaxially oriented PAS resin film to form coarse protrusions on the surface of the biaxially oriented PAS resin film is suppressed. Therefore, the biaxially oriented PAS resin film of the present invention has fine slippage and excellent peeling property despite that it has small surface roughness and is excellent in flatness.

Examples of commercially available SPS resins may include XAREC (registered trademark) Series manufactured by Idemitsu Kosan Co., Ltd. such as S104 (MFR measured at a temperature of 300° C. and under a load of 2.16 kgf=15 g/10 min), 90ZC (MFR measured at a temperature of 300° C. and under a load of 1.20 kgf=9 g/10 min), 130ZC (MFR measured at a temperature of 300° C. and under a load of 1.20 kgf=13 g/10 min) and 300ZC (MFR measured at a temperature of 300° C. and under a load of 1.20 kgf=30 g/10 min).

### 3. Biaxially Oriented PAS Resin Film

The biaxially oriented PAS resin film of the present invention is a biaxially oriented poly(arylene sulfide) resin film formed from a resin composition including a syndiotactic polystyrene resin (SPS resin) by a ratio of from 0.1 to 30 parts by mass with respect to 100 parts by mass of a poly(arylene sulfide) resin (PAS resin). The ratio of the SPS resin is preferably in the range of from 0.3 to 25 parts by mass, more preferably in the range of from 0.5 to 20 parts by mass. When the ratio of the SPS resin with respect to 100 parts by mass of the PAS resin is too small, the surface roughness can be decreased but the friction coefficients (static friction coefficient and kinetic friction coefficient) tend to increase. When the ratio of the SPS resin becomes too large, the surface roughness (center line average roughness Ra and maximum height Rmax) tends to increase.

The biaxially oriented PAS resin film of the present invention has a center line average roughness Ra measured according to the specification of JIS B 0601-1982 in the Japanese Industrial Standards in the range of from 0.01 to 0.09 μm, preferably 0.01 to 0.07. Furthermore, the biaxially oriented PAS resin film of the present invention has a maximum height Rmax measured according to the specification of JIS B 0601-1982 of 1.0 μm or less, preferably in the range of from 0.0 to 1.0 μm. The maximum height Rmax can be decreased to the range of from 0.0 to 0.9 μm or from 0.0 to 0.5 μm in many cases.

When the center line average roughness Ra becomes too large, the flatness of the biaxially oriented PAS resin film becomes insufficient. When the maximum height Rmax becomes too large, the flatness of the biaxially oriented PAS resin film becomes insufficient, and coarse protrusions adversely affect layers to which the biaxially oriented PAS resin film is attached (for example, metal oxide-deposited films, liquid crystal films, ultrathin copper foils, circuit substrates and the like).

The biaxially oriented PAS resin film of the present invention has a static friction coefficient measured according to the specification of JIS K 7125 in the Japanese Industrial Standards of 1.00 or less. The static friction coefficient of the biaxially oriented PAS resin film is in the range of preferably from 0.33 to 1.00, more preferably from 0.35 to 0.95, specifically preferably from 0.40 to 0.90.

The biaxially oriented PAS resin film of the present invention has a kinetic friction coefficient of 0.70 or less measured according to the specification of JIS K 7125. The kinetic friction coefficient of the biaxially oriented PAS resin film is in the range of preferably from 0.35 to 0.70, more preferably from 0.38 to 0.69, and specifically preferably from 0.40 to 0.68.

When the static friction coefficient and kinetic friction coefficient of the biaxially oriented PAS resin film of the present invention become too large, the slippage is decreased, thereby the film forming property, orientation property, processability and the like are decreased. Generally, the smaller the static friction coefficient and kinetic friction coefficient of the biaxially oriented PAS resin film are, the more excellent the slippage is; however, when they become excessively small, the slippage between the films becomes too high, thereby the processability and handling property may decrease.

The biaxially oriented PAS resin film of the present invention can highly balance surface flatness and slippage by having properties that relate to the above-mentioned surface roughness and friction coefficient. The biaxially oriented PAS resin film of the present invention is excellent in surface flatness, and is also excellent in the peeling property from an adherend (a material as an object of attachment) when it is used as a release film.

The biaxially oriented PAS resin film of the present invention has a draw ratio in the machine direction (MD) in the range of from 2.0 to 5.0 times and a draw ratio in the traverse direction (TD) in the range of from 2.0 to 5.0 times. The biaxially oriented PAS resin film has a thickness in the range of generally from 5 to 200 μm, preferably from 10 to 100 μm, more preferably from 20 to 80 μm. The thickness can be suitably selected depending on the purpose of use.

### 4. Process for Production of Biaxially Oriented PAS Resin Film

Although the biaxially oriented PAS resin film of the present invention may be any one as long as it has properties of the surface roughness and friction coefficients as mentioned above, and the production process therefor is not limited, it can preferably be produced by a sequential biaxial orientation process under limited conditions including the following steps 1 to 5.

(1) step 1, which includes mixing a poly(arylene sulfide) resin pellet and a syndiotactic polystyrene resin pellet so that the ratio of the syndiotactic polystyrene resin with respect to 100 parts by mass of the poly(arylene sulfide) resin becomes from 0.1 to 30 parts by mass to prepare a mixture;

(2) step 2, which includes feeding the mixture to an extruder, melt-kneading the mixture at a temperature in the range of from 280 to 340° C., melt-extruding the mixture into a sheet form from a T die attached to the tip of the extruder, and then rapidly cooling the sheet-like melt product by contacting with a casting drum whose surface temperature is retained in the range of from 20 to 60° C. to form an unstretched sheet;

(3) step 3, which includes heating the unstretched sheet by contacting with a group of rolls consisting of a preheating roll, a low-speed roll and a high-speed roll whose surface temperatures are respectively adjusted to the range of from 80 to 95° C., while monoaxially orienting the unstretched sheet between the rolls so as to have a draw ratio in the range of from 2.0 to 5.0 times in the machine direction;

(4) step 4, which includes introducing the film that has been monoaxially oriented in the machine direction into a tenter orientation machine, and heating the film under an atmosphere temperature in the range of from 80 to 95° C. while orienting the film by a draw ratio in the range of from 2.0 to 5.0 times in the traverse direction by a tenter having a shape spreading toward the end; and

(5) step 5, which includes relaxing the biaxially oriented film obtained in the step 4 at a relaxation rate in the range of from 0.5 to 7% in the traverse direction by shortening the distance between clips of the tenter orientation machine, and heat-fixing the film by retaining the film in that state in an atmosphere in the range of more than 260° C. and 295° C. or less for from 35 to 120 seconds.

In the above-mentioned step 1, the PAS resin pellet and SPS resin pellet are mixed so that the ratio of the SPS resin with respect to 100 parts by mass of the PAS resin becomes from 0.1 to 30 parts by mass to prepare a mixture. This mixing may be dry blending or the melt kneading of the two pellets. When the mixture is a pellet mixture by dry blending, the pellet mixture is fed to an extruder in the step 2. When the mixture is a melt kneaded product, the melt kneaded product is pelletized and fed to the extruder. It is preferable that the mixing is carried out by dry blending and the pellet mixture is then fed to the extruder in the above-mentioned step 2.

The ratio of the SPS resin with respect to 100 parts by mass of the PAS resin is in the range of from 0.1 to 30 parts by mass, preferably from 0.3 to 25 parts by mass, more preferably from 0.5 to 20 parts by mass. The size of each pellet is, but not limited to, in the range of generally from 1 to 10 mm, preferably from 1.5 to 8 mm, more preferably from 2 to 6 mm in both the diameter and length thereof, and where necessary, the form may be larger than that size. It is preferable to use each resin component in a pellet form since transportation property, measuring property, handling property and the like are improved.

Where desired, the PAS resin pellet and SPS resin pellet can include an antioxidant, a heat stabilizer, a light stabilizer, an ultraviolet absorber, a plasticizer, a lubricant and the like, but it is preferable to avoid incorporation of a solid additive such as an inorganic filler from the viewpoints of highly balanced surface flatness and slippage, and suppression of dropped-off particles.

In the above-mentioned step 2, the mixture, preferably a pellet mixture, is fed to an extruder and melt-kneaded at a temperature in the range of from 280 to 340° C., melt-extruded into a sheet form from a T die attached to the tip of the extruder, and the sheet-like melt product is then rapidly cooled by contacting with a casting drum whose surface temperature is retained in the range of from 20 to 60° C. to form an unstretched sheet.

The melt knead temperature in the extruder is in the range of from 280 to 340° C., preferably from 290 to 330° C., more preferably more than 300° C. and 320° C. or less. When the melt knead temperature is too low, the PAS resin does not melt sufficiently. When the melt knead temperature is too high, the SPS resin initiates thermal decomposition. By controlling the melt knead temperature to the above-mentioned range, the SPS resin can be dispersed by a suitable size in the PAS resin.

The surface temperature of the casting drum is in the range of from 20 to 60° C., preferably from 30 to 50° C. By controlling the surface temperature of the casting drum to the above-mentioned range, the crystallization of the SPS resin that has been dispersed by a suitable size in the PAS resin is promoted, thereby a biaxially oriented PAS resin film having suitable surface roughness and friction coefficients can be readily obtained.

Although the thickness of the unstretched sheet can suitably be set depending on the draw ratio and the thickness of the biaxially oriented PAS resin film, it is in the range of generally from 50 to 1,000 μm, preferably from 100 to 800 μm, more preferably from 150 to 500 μm.

In the above-mentioned step 3, the unstretched sheet is heated by contacting with a group of rolls whose surface temperatures are adjusted to the range of from 80 to 95° C. while monoaxially orienting the unstretched sheet between the rolls so as to have a draw ratio in the range of from 2.0 to 5.0 times in length in the machine direction. The orientation of the unstretched sheet in the machine direction (MD) is conducted by using the group of rolls. The group of rolls is a combination of a preheating roll, a low-speed roll (pre-orientation roll) and a high-speed roll (post-orientation roll). Each roll is constituted by a single roll or plural rolls.

By contacting the unstretched sheet with the preheating roll, the temperature of the unstretched sheet is increased smoothly to a suitable temperature for orientation. The surface temperature of the preheating roll is in the range of preferably from 80 to 90° C., more preferably from 80 to 88° C. By using the low-speed roll and high-speed roll and utilizing the difference between the rotation velocities of the respective rolls, the unstretched sheet is oriented in the monoaxial direction (MD). The difference between the rotation velocities of the low-speed roll and high-speed roll is relative one, and the rotation velocities of the respective rolls can be adjusted depending on a desired monoaxial draw ratio. The surface temperatures of the low-speed roll and high-speed roll are in the range of preferably more than 85° C. and 95° C. or less, more preferably more than 88° C. and 95° C. or less.

By contacting the unstretched sheet with the preheating roll, low-speed roll and high-speed roll that have been heated to predetermined surface temperatures, the temperature is adjusted to one suitable for orientation, and the unstretched sheet is monoaxially oriented (oriented between the rolls) in the machine direction by utilizing the difference between the rotation velocities of the low-speed roll and high-speed roll. Since the unstretched sheet and monoaxial orientation film of the present invention has fine slippage, orientation between the rolls by using the group of rolls can be carried out smoothly.

The draw ratio in the machine direction is in the range of preferably from 2.5 to 4.5 times, more preferably from 3.0 to 4.0 times. When the monoaxial draw ratio is too small, it is difficult to sufficiently improve the heat resistance, mechanical strength and the like. When the monoaxial draw ratio becomes too large, the film is broken, and heat-fixing becomes hard to be conducted.

In the above-mentioned step 4, the film that has been monoaxially oriented in the machine direction is introduced into a tenter orientation machine and heated under an atmosphere temperature in the range of from 80 to 95° C. while orienting the film by a draw ratio in the range of from 2.0 to 5.0 times in the traverse direction by a tenter having a shape spreading toward the end. Since the monoaxial orientation film of the present invention has fine slippage, it can be transported smoothly to the tenter orientation machine. In the tenter orientation machine, orientation in the traverse direction (TD) is carried out by clipping the both ends in the width direction of the monoaxial orientation film with clips, and extending the film in the width direction.

The draw ratio in the traverse direction is in the range of preferably from 2.5 to 4.5 times, more preferably from 3.0 to 4.0 times. When this draw ratio is too small, it is difficult to sufficiently improve heat resistance, mechanical strength and the like. When this draw ratio becomes too large, the film is broken, and heat-fixing becomes difficult.

In the above-mentioned step 5, the biaxially oriented film obtained in the above-mentioned step 4 is relaxed in the traverse direction (width direction) at a relaxation rate (also referred to as “mitigation rate”) in the range of from 0.5 to 7% by shortening the distance between clips of the tenter orientation machine, and heat-fixing the film by retaining the film in that state in an atmosphere in the range of more than 260° C. and 295° C. or less for from 35 to 120 seconds. The relaxation rate in the width direction is in the range of preferably from 1 to 6%, more preferably from 2 to 5%. The heat treatment temperature for heat-fixing is in the range of preferably from 265 to 290° C. The time for heat treatment is in the range of preferably from 50 to 100 seconds.

By conducting a heat treatment at a high temperature for a relatively long time under such limited relaxation conditions (also referred to as “under limited shrinkage”), a biaxially oriented PAS resin film being excellent in heat resistance, chemical resistance, resistance to hydrolysis, flame retardency, mechanical strength, electrical property, size stability and the like and also having surface roughness and friction coefficients in desired ranges can be readily obtained.

As mentioned above, the biaxially oriented PAS resin film by the production process of the present invention has a thickness in the range of generally from 5 to 200 μm, preferably from 10 to 100 μm, more preferably from 20 to 80 μm.

According to the production process of the present invention, a biaxially oriented PAS resin film having a center line average roughness Ra in the range of from 0.01 to 0.09 μm, a maximum height Rmax of 1.0 μm or less, a static friction coefficient of 1.00 or less and a kinetic friction coefficient of 0.70 or less can be produced.

### EXAMPLES

Hereinafter, the present invention is explained in more detail with referring to Examples. The physical properties and the methods for evaluating the physical properties are as follows.

### (1) Melting Viscosity:

Using about 20 g of a dried polymer as a sample, the melting viscosity thereof was measured by Capilograph 1-C manufactured by Toyo Seiki Seisaku-sho, Ltd. As a capillary, a flat die of 1 mm in diameter×10 mmL was used. The measurement temperature was 310° C. The sample was introduced in the apparatus and retained at 310° C. for 5 minutes, and the melting viscosity was measured at a shear rate of 1,200/sec.

### (2) Melt Flow Rate (MFR):

The melt flow rate (MFR) of the syndiotactic polystyrene resin was measured at a temperature of 300° C. and under a load of 1.20 kgf, or at a temperature of 300° C. and under a load of 2.16 kgf.

### (3) Melting Point (Tm):

The melting point (Tm) of the syndiotactic polystyrene resin was obtained by raising the temperature of a pellet sample under a nitrogen atmosphere from 30° C. to 300° C. at a temperature rising velocity of 20° C./minute and measuring the melt peak temperature (Tm), by using a differential scanning calorimeter manufactured by PerkinElmer. Inc.

### (4) Friction Coefficient:

The static friction coefficient and kinetic friction coefficient of film to film were measured according to the “Plastic Film and Sheet-Friction Coefficient Test Method” as specified by JIS K 7125 in the Japanese Industrial Standards.
Apparatus used: “Friction Coefficient Measuring Apparatus Type TR” manufactured by Toyo Seiki Seisaku-sho, Ltd.
Environment for measurement: temperature 23° C., relative humidity 50%
Table velocity: 100 mm/min±10 mm/min
Number of measurements: 3(n=3)

A test piece A having a size of about 80 mm×200 mm and a square test piece B having a length of 63.5 mm in each side were cut out from the biaxially oriented film. The test piece A was put on a test table of a transfer table apparatus for the measurement of friction coefficients so that the longitudinal axis of the test piece A corresponded to the longitudinal axis of the test table, and the four sides were fixed by tapes. The whole surface of the test piece B was fixed on the bottom surface of a sliding piece having a square shape having a length of 63.5 mm in each side and a weight of 192 g through a two-sided adhesive tape. The sliding piece was put on the test piece A, and the test piece B was superposed. The sliding piece was connected to a load cell through a spring. At 15 seconds after putting the sliding piece, the test table was begun to move to start recording. The maximum stress obtained first is a static friction force. By doing so, the static friction coefficient and kinetic friction coefficient between the first surface and second surface of the biaxially oriented film were measured.
Static friction coefficient μs=Fs/Fp
Fs=static friction force (g)
Fp=normal force generated by mass of sliding piece (192 g)
Kinetic friction coefficient μD=FD/Fp
FD kinetic friction force (g)
Fp=normal force generated by mass of sliding piece (192 g)

### (5) Surface Roughness (Ra and Rmax):

According to the specification of JIS B 0601-1982 in the Japanese Industrial Standards, the center line average roughness (center-line-average roughness) Ra and maximum height (maximum height of irregularities) Rmax of the biaxially oriented film were measured by a surface roughness measurement process using a probe.
Apparatus used: Surfcom 550A manufactured by Tokyo Seimitsu Co., Ltd.
Measurement velocities:
0.3 mm/sec (cutoff 0.25 mm)
0.03 mm/sec (cutoff 0.08 mm)
Measurement length: 2.4 mm

The maximum height Rmax refers to a value represented by μm, which is obtained by removing a part having a standard line length from a cross-sectional surface curve (primary profile), interposing the removed part between two straight lines that are in parallel to the parallel line of the removed part, and measuring the interval of this two straight lines in the direction of the longitudinal magnification of the cross-sectional surface curve.

As the cutoff value, 0.25 mm or 0.08 mm was adopted on the basis whether or not the waviness frequency around an amplitude of 1.0 μm in a three-dimensional surface roughness graph is observed. The cutoff means that unnecessary waviness components are truncated from a cross-sectional surface curve during measurement of a surface roughness. When the waviness frequency (surface roughness wavelength) is short, a small cutoff value is generally used. When waviness having a frequency of around 100 μm was observed, the cutoff value was set to 0.25 mm, and when the waviness was not observed, the cutoff value was set to 0.08 mm For a biaxially oriented film in which waviness was not observed, the measurement velocity was slowed so that the surface profile could be followed in more detail.

### (6) Peeling Property:

The both surfaces of a prepreg that had been impregnated with an epoxy resin [an epoxy multilayer prepreg for printed-wiring boards FR-4 (part number: EI-6765), manufactured by Sumitomo Bakelite Co., Ltd.] were interposed between the biaxially oriented films and retained at 125° C. for 30 minutes by using a press machine to semi-cure the epoxy resin, and the prepreg was cured by heat pressing for 45 minutes under conditions of a temperature of 175° C. and a pressure of 2.2 MPa. The biaxially oriented films were peeled off from the cured prepreg by hands, and at that time, the peeling property of the biaxially oriented films was evaluated according to the following criteria.
A: the biaxially oriented film can be readily peeled off without causing breakage and tearing of the film;
B: the biaxially oriented film can be peeled off, but the biaxially oriented film is broken or torn in some cases depending on the means for peeling, and thus the film is slightly poor in operatability;
C: the biaxially oriented film has strong adhesion force and thus cannot be readily peeled off.

### Example 1

A linear poly(phenylene sulfide) powder (melting viscosity 160 Pa·s) was fed to an extruder and melt-extruded into a shape of a strand, and the strand was solidified by immersing into a cooling water bath and cut by using a pelletizer for strands to prepare pellets (hereinafter referred to as “PPS pellet”).

On the other hand, pellets of a syndiotactic polystyrene [“XAREC (registered trademark) S104” manufactured by Idemitsu Kosan Co., Ltd.; an MFR measured at a temperature of 300° C. and under a load of 2.16 kgf=15 g/10 min, Tm=271° C.] (hereinafter referred to as “SPS pellets (a)”) were pre-dried by retaining under an atmosphere at 80° C. for 3 hours.

The SPS pellets (a) were added by a ratio of 0.5 parts by mass with respect to 100 parts by mass of the PPS pellets and mixed by using a blender to prepare a pellet mixture. The pellet mixture was put into an extruder having a diameter of 35 mm, melt-kneaded at 310° C., and melt-extruded into a sheet form from a T die (die width=300 mm, lip clearance=0.6 mm) attached to the tip of the extruder. The sheet-like melt product from the T die was cooled rapidly by casting on a casting drum made of a metal whose surface temperature was retained at 40° C., thereby an unstretched sheet having a thickness of about 400 μm was prepared.

The temperature of the unstretched sheet was raised by contacting with the surface of a preheating roll whose surface temperature had been adjusted to 85° C., and the unstretched sheet was then heated by contacting with the surface of a heating roll whose surface temperature had been adjusted to 90° C. and oriented in the machine direction (MD) between the rolls so that the length became 3.6 times. The film that had been oriented in the machine direction was then introduced into a tenter orientation machine, and oriented in the traverse direction (TD) to 3.4 times at an atmosphere temperature of 92° C. in a tenter having a shape spreading toward the end. After the orientation, the biaxially oriented film was relaxed by 4% in the traverse direction by decreasing the distance between the clips of the tenter orientation machine, and heat-fixed by retaining the film at that state in an atmosphere of 270° C. for 75 seconds. By doing so, a biaxially oriented film having a thickness of about 35 μm was prepared. From the preparation of the unstretched sheet to the preparation of the biaxially oriented film were carried out in continuous steps. The results are shown in Table 1. (The cutoff value during measurement of the surface roughness=0.08 mm)

### Example 2

A biaxially oriented film was prepared in a similar manner to that of Example 1, except that the ratio of the SPS pellets (a) was changed from 0.5 part by mass to 2.0 parts by mass. The results are shown in Table 1. (The cutoff value during measurement of the surface roughness=0.08 mm)

### Example 3

A biaxially oriented film was prepared in a similar manner to that of Example 1, except that the pellets of the syndiotactic polystyrene were changed from the pellet (a) of XAREC (registered trademark) S104 manufactured by Idemitsu Kosan Co., Ltd. to pellets of XAREC (registered trademark) 90ZC (racemic pentad tacticity=98%, MFR measured at a temperature of 300° C. and under a load of 1.20 kgf=9 g/10 min, Tm=272° C.) manufactured by the same company, and that the ratio thereof was changed from 0.5 part by mass to 10.0 parts by mass. The results are shown in Table 1. (The cutoff value during measurement of the surface roughness=0.25 mm)

### Example 4

A biaxially oriented film was prepared in a similar manner to that of Example 3, except that the ratio of the SPS pellets (b) was changed from 10.0 parts by mass to 20.0 parts by mass. The results are shown in Table 1. (The cutoff value during measurement of the surface roughness=0.25 mm)

### Comparative Example 1

A biaxially oriented film was prepared in a similar manner to that of Example 1, except that the PPS pellets as used in Example 1 were used solely. The results are shown in Table 1. (The cutoff value during measurement of the surface roughness=0.08 mm)

### Comparative Example 2

0.3 part by mass of calcium carbonate [“NITOREX (registered trademark) #30PS” manufactured by Nitto Funka Kogyo K. K.; average particle size=0.7 μm] and 0.2 part by mass of calcium stearate [“Ca-St” manufactured by Nitto Kasei Kogyo Co., Ltd.; lubricant] were added with respect to 100 parts by mass of a linear poly(phenylene sulfide) powder (melting viscosity 160 Pa·s), mixed in a blender, and pelletized in a similar manner to that of Example 1. A biaxially oriented film was prepared in a similar manner to that of Example 1, except that this calcium carbonate-containing PPS pellets were used solely. The results are shown in Table 1. (The cutoff value during measurement of the surface roughness=0.08 mm)

### Comparative Example 3

A pellet mixture was prepared in a similar manner to that of Example 1, except that pellets of a polyethylene telephthalate [“Mitsui PET J125S”, manufactured by Mitsui Chemicals, Inc.] were added by a ratio of 2.0 parts by mass with respect to 100 parts by mass of PPS pellets as used in Example 1, and a biaxially oriented film was then prepared. The results are shown in Table 1. (The cutoff value during measurement of the surface roughness=0.08 mm)

### Comparative Example 4

A pellet mixture was prepared in a similar manner to that of Example 1, except that pellets of a high density polyethylene [“Hi-Zex (registered trademark) 5000SF” manufactured by Mitsui Chemicals, Inc.] were added by a ratio of 2.0 parts by mass with respect to 100 parts by mass of PPS pellets as used in Example 1, and a biaxially oriented film was then prepared. The results are shown in Table 1. (The cutoff value during measurement of the surface roughness=0.25 mm)

### Comparative Example 5

The above-mentioned SPS pellets (a) were added by a ratio of 5 parts by weight with respect to 100 parts by mass of PPS pellets as used in Example 1, and mixed by using a blender to prepare a pellet mixture. This pellet mixture was put into an extruder having a diameter of 35 mmφ, melt-extruded into a strand shape at a resin temperature of 305° C., and cut in cooled water to prepare pellets. These pellets were put into an extruder having a diameter of 35 mm, melt-kneaded at 310° C., and melt-extruded into a sheet form from a T die (die width=300 mm, lip clearance=0.6 mm) attached to the tip of the extruder. The sheet-like melt product from the T die was cooled rapidly by casting on a casting drum made of a metal whose surface temperature was retained at 40° C., thereby an unstretched sheet having a thickness of about 400 μm was prepared.

This unstretched sheet was subjected to simultaneous biaxial orientation at an orientation temperature of 98° C. and draw ratios of 3.6 (machine direction)×3.4 (traverse direction) times, and then heat-fixed at 260° C. for 30 seconds to give a biaxially oriented film. The results are shown in Table 1. (The cutoff value during measurement of the surface roughness=0.25 mm)

TABLE 1

| | | | | | | Biaxially oriented film | | | | | | | |
|---|---|---|---|---|---|---|---|---|---|---|---|---|---|
| | | | | | | Orienta- | | | | | | | |
| | | | | | | tion | | Surface roughness | | Friction coefficient | | | |
| | Resin Composition | | | | | magnifica- | | Center line | Maximum | Static | Kinetic | | |
| | | | | Inorganic | | tion | Thick- | average | height | friction | friction | | Biaxial |
| | | Resin | | filler | | (machine/ | ness | roughness | Rmax | coefficient | coefficient | Peeling | orientation |
| | PPS | Kind | Parts | Kind | Parts | traverse) | (μm) | Ra (μm) | (μm) | μ_{S} | μ_{D} | property | process |
| Example 1 | 100 | SPS(a) | 0.5 | — | — | 3.6/3.4 | 35 | 0.01 | 0.0 | 0.53 | 0.45 | B | Sequential |
| Example 2 | 100 | SPS(a) | 2.0 | — | — | 3.6/3.4 | 35 | 0.03 | 0.9 | 0.42 | 0.44 | A | Sequential |
| Example 3 | 100 | SPS(b) | 10.0 | — | — | 3.6/3.4 | 35 | 0.04 | 0.5 | 0.84 | 0.67 | A | Sequential |
| Example 4 | 100 | SPS(b) | 20.0 | — | — | 3.6/3.4 | 35 | 0.07 | 1.0 | 0.63 | 0.54 | A | Sequential |
| Comp. | 100 | — | — | — | — | 3.6/3.4 | 35 | 0.01 | 0.0 | 1.47 | 0.75 | C | Sequential |
| Ex. 1 | | | | | | | | | | | | | |
| Comp. | 100 | — | — | CaCO₃ | 0.3 | 3.6/3.4 | 35 | 0.03 | 1.1 | 0.43 | 0.42 | C | Sequential |
| Ex. 2 | | | | Ca-St | 0.2 | | | | | | | | |
| Comp. | 100 | PET | 2.0 | — | — | 3.6/3.4 | 35 | 0.03 | 1.2 | 0.74 | 0.57 | C | Sequential |
| Ex. 3 | | | | | | | | | | | | | |
| Comp. | 100 | HDPE | 2.0 | — | — | 3.6/3.4 | 35 | 0.10 | 1.8 | 0.31 | 0.33 | C | Sequential |
| Ex. 4 | | | | | | | | | | | | | |
| Comp. | 100 | SPS(a) | 5.0 | — | — | 3.6/3.4 | 33 | 0.10 | 1.6 | 0.36 | 0.40 | A | Simultaneous |
| Ex. 5 | | | | | | | | | | | | | |

(Footnote)
(1) PPS: linear poly(phenylene sulfide) resin (melting viscosity 160 Pa · s)
(2) SPS (a): syndiotactic polystyrene [“XAREC (registered trademark) S104” manufactured by Idemitsu Kosan Co., Ltd.]
(3) SPS (b): syndiotactic polystyrene [“XAREC (registered trademark) 90ZC” manufactured by Idemitsu Kosan Co., Ltd.]
(4) CaCO3: calcium carbonate [“NITOREX (registered trademark) #30PS” manufactured by Nitto Funka Kogyo K.K.; average particle size = 0.7 μm]
(5) Ca-St: calcium stearate [“Ca-St” manufactured by Nitto Kasei Kogyo Co., Ltd.; lubricant]
(6) PET: polyethylene telephthalate [“Mitsui PET J125S” manufactured by Mitsui Chemicals, Inc.]
(7) HDPE: high density polyethylene [“Hi-Zex (registered trademark) 5000SF” manufactured by Mitsui Chemicals, Inc.]

### <Discussion>

As is apparent from the results in Table 1, the biaxially oriented film of the PPS resin (Comparative Example 1) had both a small center line average roughness Ra and a small maximum height Rmax and was excellent in flatness, but had a large static friction coefficient and a large kinetic friction coefficient and bad slippage between the films. Therefore, the biaxially oriented film of Comparative Example 1 was difficult to wind. Furthermore, the biaxially oriented film of Comparative Example 1 had bad peeling property.

The biaxially oriented film formed from the PPS resin composition including calcium carbonate and calcium stearate (Comparative Example 2) had a small center line average roughness Ra and also had a small static friction coefficient and a small kinetic friction coefficient, whereas the maximum height Rmax was high due to the secondary flocculate of the inorganic microparticles such as calcium carbonate microparticles. Therefore, the biaxially oriented film of Comparative Example 2 had insufficient surface flatness. The biaxially oriented film of Comparative Example 2 had bad peeling property.

The biaxially oriented film that was formed from the resin composition obtained by adding a polyethylene telephthalate to the PPS resin (Comparative Example 3) had a small center line average roughness Ra and also had a small static friction coefficient and a small kinetic friction coefficient, but had a high maximum height Rmax. The biaxially oriented film of Comparative Example 3 had not only bad surface flatness but also bad flatness due to occurrence of slack.

The biaxially oriented film that was formed from the resin composition obtained by adding a high density polyethylene to the PPS resin (Comparative Example 4) had a large center line average roughness Ra and a high maximum height Rmax, and thus was poor in surface flatness. The biaxially oriented film of Comparative Example 4 was difficult to be subjected to continuous film formation.

The simultaneously biaxially oriented film that was formed from the resin composition obtained by incorporating a syndiotactic polystyrene [“XAREC (registered trademark) S104”, manufactured by Idemitsu Kosan Co., Ltd.] by a ratio of 5 parts by mass with respect to 100 parts by mass of the PPS resin (Comparative Example 5) had a high center line average roughness Ra and a high maximum height Rmax, and was poor in surface flatness.

In contrast to this, it is understood that the biaxially oriented PPS resin films of the present invention (Examples 1 to 4) had both a small center line average roughness Ra and a small maximum height Rmax and thus were excellent in surface flatness. Despite that these biaxially oriented PPS resin films were excellent in flatness, they had both a small static friction coefficient and a small kinetic friction coefficient, and also had fine slippage. Furthermore, the biaxially oriented PAS resin films of the present invention were also excellent in peeling property.

### INDUSTRIAL APPLICABILITY

The biaxially oriented poly(arylene sulfide) resin film of the present invention is excellent in heat resistance, chemical resistance, resistance to hydrolysis, flame retardency, mechanical strength, electrical property, size stability and the like, and can be used in a wide variety of technical fields for which excellent flatness, slippage, release property and the like are required. The biaxially oriented poly(arylene sulfide) resin film of the present invention can be preferably utilized as, for example, a carrier film used for the production of liquid crystal films and ultrathin copper foils, an electrical/electronic part such as a condenser film and an insulating film, a release film used in the steps for the production of circuit substrates, or the like.

1. A biaxially oriented poly(arylene sulfide) resin film formed from a resin composition comprising a syndiotactic polystyrene resin by a ratio of from 0.1 to 30 parts by mass with respect to 100 parts by mass of a poly(arylene sulfide) resin, which has
(a) a center line average roughness Ra in the range of from 0.01 to 0.09 μm and a maximum height Rmax of 1.0 μm or less, which are measured according to the specification of JIS B 0601-1982 in the Japanese Industrial Standards, and
(b) a static friction coefficient of 1.00 or less and a kinetic friction coefficient of 0.70 or less, which are measured according to the specification of the specification of JIS K 7125 in the Japanese Industrial Standards.

2. The film according to claim 1, wherein the poly(arylene sulfide) resin is a poly(phenylene sulfide) resin that has a melting viscosity in the range of from 20 to 2,000 Pa·s when it is measured at a temperature of 310° C. and a shear rate of 1,200/sec.

3. The film according to claim 1, wherein the syndiotactic polystyrene resin shows a racemic pentad tacticity of 50% or more when it is quantified by a nuclear magnetic resonance method.

4. The film according to claim 1, wherein the syndiotactic polystyrene resin has a weight average molecular weight in the range of from 10,000 to 1,000,000 when it is measured by gel permeation chromatography, and has a melt flow rate in the range of from 3 to 50 g/10 min when it is measured at a temperature of 300° C. and under a load of 1.20 kgf.

5. The film according to claim 1, wherein the syndiotactic polystyrene resin has a melting point in the range of from 250 to 310° C. when it is measured by using a differential scanning calorimeter.

6. The film according to claim 1, which has a center line average roughness Ra in the range of from 0.01 to 0.07 μm and a maximum height Rmax in the range of from 0.0 to 1.0 μm.

7. The film according to claim 1, which has a static friction coefficient in the range of from 0.33 to 1.00 and a kinetic friction coefficient in the range of from 0.35 to 0.70.

8. The film according to claim 1, which is a sequential biaxially oriented film having a draw ratio in the machine direction in the range of from 2.0 to 5.0 times and a draw ratio in the traverse direction in the range of from 2.0 to 5.0 times.

9. A process for the production of a biaxially oriented poly(arylene sulfide) resin film, which comprises the following steps 1 to 5:
(1) step 1, which comprises mixing a poly(arylene sulfide) resin pellet and a syndiotactic polystyrene resin pellet so that the ratio of the syndiotactic polystyrene resin with respect to 100 parts by mass of the poly(arylene sulfide) resin becomes from 0.1 to 30 parts by mass to prepare a mixture;
(2) step 2, which comprises feeding the mixture to an extruder, melt-kneading the mixture at a temperature in the range of from 280 to 340° C., melt-extruding the mixture into a sheet form from a T die attached to the tip of the extruder, and then contacting the sheet-like melt product with a casting drum whose surface temperature is retained in the range of from 20 to 60° C. to rapidly cool the sheet-like melt product to form an unstretched sheet;
(3) step 3, which comprises heating the unstretched sheet by contacting with a group of rolls consisting of a preheating roll, a low-speed roll and a high-speed roll whose surface temperatures are respectively adjusted to the range of from 80 to 95° C., while monoaxially orienting the unstretched sheet between the rolls so as to have a draw ratio in the range of from 2.0 to 5.0 times in the machine direction;
(4) step 4, which comprises introducing the film that has been monoaxially oriented in the machine direction into a tenter orientation machine, and heating the film under an atmosphere temperature in the range of from 80 to 95° C. while orienting the film by a draw ratio in the range of from 2.0 to 5.0 times in the traverse direction by a tenter having a shape spreading toward the end; and
(5) step 5, which comprises relaxing the biaxially oriented film obtained in the step 4 at a relaxation rate in the range of from 0.5 to 7% in the traverse direction by shortening the distance between clips of the tenter orientation machine, and heat-fixing the film by retaining the film in that state in an atmosphere in the range of more than 260° C. and 295° C. or less for from 35 to 120 seconds.

10. The production process according to claim 9, wherein a biaxially oriented poly(arylene sulfide) resin film having
(a) a center line average roughness Ra in the range of from 0.01 to 0.09 μm and a maximum height Rmax of 1.0 μm or less, which are measured according to the specification of JIS B 0601-1982 in the Japanese Industrial Standards, and
(b) a static friction coefficient of 1.00 or less and a kinetic friction coefficient of 0.70 or less, which are measured according to the specification of the specification of JIS K 7125 in the Japanese Industrial Standards, is produced by the steps 1 to 5.

11. The production process according to claim 9, wherein the step 1 comprises preparing the pellet mixture by mixing the poly(arylene sulfide) resin pellet and the syndiotactic polystyrene resin pellet so that the ratio of the syndiotactic polystyrene resin with respect to 100 parts by mass of the poly(arylene sulfide) resin becomes from 0.1 to 30 parts by mass.

12. The production process according to claim 9, wherein the step 2 comprises feeding the mixture prepared in the step 1 to an extruder, melt-kneading the mixture at a temperature in the range of more than 300° C. and 320° C. or less, melt-extruding the mixture into a sheet form from a T die attached to the tip of the extruder, and then rapidly cooling the sheet-like melt product by contacting with a casting drum whose surface temperature is retained in the range of from 30 to 50° C. form an unstretched sheet having a thickness in the range of from 50 to 1,000 μm.

13. The production process according to claim 9, wherein the step 3 comprises contacting the unstretched sheet formed in the step 2 with the preheating roll whose surface temperature is adjusted to the range of from 80 to 90° C., and thereafter heating the unstretched sheet by contacting with a group of rolls consisting of the low-speed roll and high-speed roll whose surface temperatures are adjusted to the range of more than 85° C. and 95° C. or less while monoaxially orienting the unstretched sheet between the rolls so as to have a draw ratio in the range of from 2.5 to 4.5 times in the machine direction.

14. The production process according to claim 9, wherein the step 4 comprises introducing the film that has been monoaxially oriented in the machine direction in the step 3 into a tenter orientation machine, and heating the film under an atmosphere temperature in the range of from 80 to 95° C. while orienting the film by a draw ratio in the range of from 2.5 to 4.5 times in the traverse direction by a tenter having a shape spreading toward the end.

15. The production process according to claim 9, wherein the step 5 comprises relaxing the biaxially oriented film formed in the step 4 at a relaxation rate in the range of from 1 to 6% in the traverse direction by shortening the distance between the clips of the tenter orientation machine, and heat-fixing the film by retaining the film in that state in an atmosphere in the range of from 265° C. to 290° C. for from 50 to 100 seconds.
